(19) United States
(12) Patent Application Publication
(10) Pub. No.: US 2018/0076892 A1
(43) Pub. Date: Mar. 15, 2018

(54) REDUCING FLICKER IN A CODED LIGHT

(71) Applicant: PHILIPS LIGHTING HOLDING B.V., EINDHOVEN (NL)

(72) Inventors: JOOST JACOB BRILMAN, VELDHOVEN (NL); CONSTANT PAUL MARIE JOZEF BAGGEN, BLERICK (NL)

(21) Appl. No.: 15/559,234

(22) PCT Filed: Mar. 1, 2016
(86) PCT No.: PCT/EP2016/054315

§ 371 Date: Sep. 18, 2017

(30) Foreign Application Priority Data
Mar. 17, 2015 (EP) 15159411.6

(51) Int. Cl. H04B 10/116; H05B 33/08; H04B 10/516; H04B 10/67; H04B 10/50

(52) U.S. Cl. CPC H04B 10/116; H05B 33/0845; H04B 10/502; H04B 10/67; H04B 10/516

(57) ABSTRACT

A drive signal is generated, describing a waveform having discrete levels used to represent packets of data interspersed with idle periods, the data being encoded according to an at least three-level code, which is DC-free in that, at least when the data is substantially random, the symbol values average to the value of the zero symbol. The drive signal is used to drive a light source, and thereby transmit the encoded signal embedded in the emitted visible light. At least when the data is substantially random, the levels of the drive signal have a predetermined average DC level during the packets; and the modulation comprises representing the idle periods using a DC-free modulation alternating between a plurality of levels comprising at least a first and a second level, such that over each idle period the levels average to said predetermined DC level of the packets.

### TECHNICAL FIELD

The present disclosure relates to the communication of coded light signals embedded in the light emitted by a light source, and particularly to schemes for modulating the signal into the light so as to reduce visible flicker.

### BACKGROUND

Coded light refers to a technique whereby data is modulated into the visible illumination emitted by a light source, e.g. by an LED based luminaire. Thus in addition to providing illumination (for which purpose a light source may already be present in an environment), the light source also acts as a transmitter capable of transmitting data to a suitable receiver of coded light. The modulation is performed at a high enough frequency that it is substantially imperceptible to human vision, i.e. so the user only perceives the overall illumination and not the effect of the data being modulated into that illumination (or the effect is relatively negligible or at least tolerable). In this way the data may be said to be embedded into the light from the light source.

Coded light can be used in a number of applications. For instance, one application is to transmit information from a luminaire to a remote control unit for controlling that luminaire, e.g. to transmit an identifier distinguishing it amongst other such luminaires in the environment which the remote unit can control, or to transmit status information of the luminaire (e.g. to report errors, warnings, temperature, operating time, etc.). In one such example, the remote control unit may comprise a mobile user terminal such as smart phone or tablet having an inbuilt camera. With the terminal running a suitable application, the user can direct the camera at a luminaire and thereby detect the identifier coded into the light from that luminaire. Given the identifier of the luminaire it is looking at, the terminal may then control that luminaire by sending back a return signal via a suitable back channel (e.g. via RF).

In another application the coded light may be used to provide information for the benefit of a user, e.g. to provide identifiers of the luminaires for use in commissioning, or to enable provision of location related information. For example each luminaire in an indoor and/or outdoor environment (e.g. in the rooms and corridors of an office complex, and/or paths of a campus) may be arranged to emit light embedded with a respective identifier identifying it within that environment. If a user has a mobile terminal equipped with a camera, and an associated application for detecting coded light, the terminal can detect the identifier of a luminaire illuminating its current location. This can then be used to help the user navigate the environment, by looking up the current location in a location database mapping the identifiers to locations of the luminaires. Alternatively or additionally, this may be used to look up information associated with the user's current location, such as information on exhibits in particular rooms of a museum. E.g. the look up may be performed via the Internet or a local network to which the terminal has access, or from a local database on the user terminal. Alternatively the information could be directly coded into the light from one or more luminaires. Generally speaking, the applicability of coded light is not limited.

Data is modulated into the light by means of a technique such as amplitude modulation or duty cycle modulation, whereby the modulated property (e.g. amplitude or duty cycle) is used to represent channel symbols. The modulation typically involves a coding scheme to map data bits (sometimes referred to as user bits) onto such channel symbols. An example is a conventional Manchester code, which is a binary code whereby a user bit of value 0 is mapped onto a channel symbol in the form of a low-high pulse and a user bit of value 1 is mapped onto a channel symbol in the form of a high-low pulse. Another example is the recently developed ternary Manchester code, described in international patent application publication no. WO2012/052935.

### SUMMARY

One consideration in designing a system that uses visible light to transmit data (coded light) is to reduce the flicker observed by the human eye, or at least that flicker should be relatively negligible. This aim is generally met by using special data formats such as Ternary Manchester in combination with a relatively complex driver of the light source. However, these drivers tend to be costly and/or cumbersome and so are not necessarily desirable for all applications. It would be desirable to provide a modulation techniques that damps the low frequency light flicker even when used with less complex and/or cheaper drivers.

In coded light, the data is typically transmitted according to a packet-based format, whereby the signal takes the form of a series of data packets with an idle period interspersed between each pair of consecutive packets in the series. The transitions between data packets and idle periods are the main source of low frequency components in the light intensity. These low frequency components can be reduced by transmitting the packets using a DC free code. That is to say, the modulated data symbols within a packet represent, on average, an equal light intensity as the idle periods in between the data packets. Examples of DC free codes include Manchester encoding and Ternary Manchester. Thus in principle, the average DC level of each packet should be zero, as in the idle periods, and hence there should be no variation between the data packets and the idle periods.

However, in reality, when this signal is output via an imperfect driver, the DC level of the packets in the actual light is not exactly equal to the idle level. To address this, the present invention provides a scheme in which the light is modulated during the idle period as well as in the data packets themselves.

If as in the conventional case the idle period is just all 0s, then the driver is simply operating at a constant level, and so does not experience the same offset due to driver imperfection as in the packets. E.g. so in the case of driving an LED with a three or five level code, the driver is still producing the average LED current (approximately proportional to light output) on top of which the coded-light symbols are modulated in a packet. The signal energy during an idle period is equal to that of a ‘0’ symbol. Real drivers however are imperfect (e.g. non-linear) and so fail to create +/− symbols around this ‘0’ symbol level in a symmetrical and/or evenly distributed way, meaning that in the actual modulated light the packet is not in fact DC free relative to the ‘0’ level.

But if as recognized herein the light is also modulated in the idle periods, then the same or similar driver imperfections will be experienced in the idle periods as are already occurring in the packets, and hence the same or similar offset as in the supposedly DC free code. This eliminates or at least reduces the variation in DC level between the packets and the idle periods, and thus reduces flicker.

Hence according to one aspect disclosed herein, there is provided a controller comprising: a modulator configured to generate a drive signal for driving a driver of a light source so as to transmit a signal embedded in visible light emitted by the light source, the drive signal describing a waveform having discrete levels used to represent packets of encoded data interspersed with idle periods, wherein the packets of data are encoded according to an at least three-level code comprising a set of at least three discrete symbols in the form of a zero symbol corresponding to an average symbol value, at least one positive symbol corresponding to a higher symbol value, and at least one negative symbol corresponding to a lower symbol value, wherein the code is DC-free in that, at least when the data is substantially random, the symbol values average to said average symbol value; wherein at least when the data is substantially random, the levels of the drive signal have a predetermined average DC level during the packets; and the modulator is configured so as, in the drive signal, to represent the idle periods using a DC-free modulation alternating between a plurality of levels comprising at least a first level and a second level, the DC-free modulation being DC-free in that over each of the idle periods the levels average to said predetermined DC level of the packets.

Preferably, in the drive signal, the data is encoded at a symbol rate of said symbols, and at least during the idle periods the modulation alternates between the first and second levels at a higher frequency than said symbol rate. For example, during the idle periods the modulation may alternate between the first and second levels at twice the symbol rate.

In embodiments, each of the idle periods may correspond to a sequence of the zero symbols, and said modulation may comprise representing each of the zero-symbols of the idle periods in the drive signal by a symbol waveform comprising a combination of the first and second levels.

Said modulation may be a bi-level modulation, comprising only the first and second levels.

Further, the modulation may comprise, in the drive signal, representing each instance of the zero symbol with a symbol waveform consisting of an equal duration of the first and the second levels.

Three-or-more symbol codes are advantageous in that their frequency response falls off more significantly towards zero hertz than simple two-level codes. For instance ternary Manchester is DC² free, meaning that not only does the frequency response (the signal contribution Y plotted against frequency) go to zero at zero Hertz, but the gradient of the frequency response (i.e. the first differential of the response with respect to frequency) also goes to zero at zero hertz. Other three-or-more level codes may also be designed having the DC² free property.

However, on the other hand, three-or-more level modulation suffers from the problem discussed above that they are susceptible to DC components being introduced due to driver imperfections. Practically it is not possible to design a perfect driver that represents the −1 and +1 symbols with exactly the same magnitude offset (in the opposite direction) relative to the level of the level of the zero symbol. E.g. if 0 is represented by 80% intensity, and −1 and +1 are notionally to be represented by 70% and 80% intensity respectively, it is impossible to design a perfect driver which achieves this and in reality the − and + levels will be, say, something like 70.5% and 90.5%, meaning the average is not at the zero level of 80%. Two-level modulation in itself does not suffer from such issues because there is no middle symbol (and the DC simply always fall somewhere between the two levels) and hence no need to worry about whether the − and + levels matches the level representing the middle 0 symbol.

It would be desirable to achieve the lower-end DC roll-off (e.g. DC² free property) of three-or-more symbol codes, while retailing the robustness to driver imperfections of two-level modulation.

Hence in particularly preferred embodiments, each of the idle periods corresponds to a sequence of the zero symbols; and the modulator is configured so as, in the drive signal, to use the DC-free modulation to represent both the idle periods and the packets, by representing each of instance of each said symbols using one or both of the first and second levels.

For instance, the at least one positive symbol of said set may comprise a +1 symbol, and the at least one negative symbol of said set may comprise a −1 symbol; and said modulation may comprise, in the drive signal, representing each of the zero symbols with an equal duration of the first and the second levels, representing each of the +1 symbols by only the first level, and representing each of the −1 symbols by only the second level.

The symbols of said at least three-level code may correspond to an odd number of levels with an equal number of evenly spaced levels either side of the zero level.

In embodiments, said code may be an at least five level code, e.g. an exactly five level code.

For instance, the positive symbols of said set may comprise a +½ symbol and a +1 symbol, and the negative symbols of said set may comprise a −½ symbol and a −1 symbol; and said modulation may comprise, in the drive signal, representing each of the zero symbols with a symbol waveform consisting of an equal duration of the first and the second levels, representing each of the +1 symbols by only the first level, representing each of the −1 symbols by only the second level, and representing each of the +½ symbols with a symbol waveform consisting of three quarters duration of the first level to one quarter duration of the second level, and representing each instance of the −½ symbol with a symbol waveform consisting of one quarter duration of the first level and three quarters duration of the second level.

In further embodiments, said modulation may at least comprise, in the drive signal, representing each instance of the zero symbol during the idle periods with a symbol waveform comprising a combination of said first and second levels, and representing each of instance of the zero symbol during the packets with the same symbol waveform but 90 degrees out of phase with the zero symbols of the idle periods.

According to another aspect disclosed here, there is provided a method of embedding data in visible light emitted by a light source, the method comprising: generating a drive signal describing a waveform having discrete levels used to represent a sequence of packets of encoded data interspersed with idle periods, wherein the packets of data are encoded according to an at least three-level code comprising a set of at least three discrete symbols in the form of a zero symbol corresponding to an average symbol value, at least one positive symbol corresponding to a higher symbol value, and at least one negative symbol corresponding to a lower symbol value, wherein the code is DC-free in that, at least when the data is substantially random, the symbol values average to said average symbol value being the value of the zero symbol; and driving a driver of the light source with the drive signal so as to transmit the sequence of packets and idle periods embedded in the emitted visible light; wherein, at least when the data is substantially random, the levels of the drive signal have a predetermined average DC level during the packets; and wherein the method comprises, in the drive signal, representing the idle periods using a DC-free modulation alternating between a plurality of levels comprising at least a first level and a second level, the DC-free modulation being DC-free in that over each of the idle periods the levels average to said predetermined DC level of the packets.

According to another aspect disclosed herein, there is provided a method comprising receiving the light embedded with the sequence according to any of the techniques disclosed herein, and low pass filtering the embedded signal so as to average out the modulation between the first and second levels per symbol, and thereby recover the symbol values of said at least three-level code.

According to another aspect of the present disclosure, there is provided a computer program product for embedding data in visible light emitted by a light source, the computer program product comprising embodied on a computer-readable storage medium and/or being downloadable therefrom, configured so as when run on a controller of the light source to perform operations of: generating a drive signal describing a waveform having discrete levels used to represent a sequence of packets of encoded data interspersed with idle periods, wherein the packets of data are encoded according to an at least three-level code comprising a set of at least three discrete symbols in the form of a zero symbol corresponding to an average symbol value, at least one positive symbol corresponding to a higher symbol value, and at least one negative symbol corresponding to a lower symbol value, wherein the code is DC-free in that, at least when the data is substantially random, the symbol values average to said average symbol value being the value of the zero symbol; and driving a driver of the light source with the drive signal so as to transmit the sequence of packets and idle periods embedded in the emitted visible light; wherein, at least when the data is substantially random, the levels of the drive signal have a predetermined average DC level during the packets; and wherein the method comprises, in the drive signal, representing the idle periods using a DC-free modulation alternating between a plurality of levels comprising at least a first level and a second level, the DC-free modulation being DC-free in that over each of the idle periods the levels average to said predetermined DC level of the packets.

According to yet another aspect disclosed herein, there is provided a signal comprising visible light modulated with a modulation waveform representing packets of data interspersed with idle periods, the packets of data having been encoded according to an at least three-level code based on a set of at least three discrete symbols in the form of a zero symbol corresponding to an average symbol value, at least one positive symbol corresponding to a higher symbol value, and at least one negative symbol corresponding to a lower symbol value, wherein the code is DC-free in that, at least when the data is substantially random, the symbol values average to said average symbol value being the value of the zero symbol; and wherein: the modulation waveform uses discrete levels to represent the idle periods and the symbols of the encoded data; at least when the data is random, the modulation waveform has a predetermined average DC level during the packets; and the idle periods are represented in the modulation waveform using a modulation alternating between a plurality of levels comprising at least a first level and a second level, and over each of the idle periods the first and second levels average to said predetermined DC level of the packets.

In embodiments, the method, computer program or signal may comprise further features in accordance with any of the techniques disclosed herein.

According to alternative aspects of the present disclosure, the above-mentioned technique of using a bi-level modulation to represent three-or-more symbols, may even be used alone in a scenario where the data is transmitted continually without using a packet-based format involving idle periods (the data being transmitted continually over a period too long to significantly contribute to visible flicker, e.g. >0.1 s, >1 s or even >10 s ). The bi-level representation of the three-or-more level code could even be used without idle period modulation in a scenario where the idle periods are short enough relative to the packets not to significantly contribute to visible flicker (being insignificant in terms of the user's perception).

Hence according to one aspect disclosed herein, there is provided a controller comprising a modulator configured to generate a drive signal for driving a driver of a light source so as to transmit a signal embedded in visible light emitted by the light source, the drive signal describing a waveform having discrete levels used to represent encoded data, wherein the packets of data are encoded according to an at least three-level code comprising a set of at least three discrete symbols; wherein the modulator is configured so as, in the drive signal, to represent each of the symbols of the at least three symbol code using a two-level modulation consisting of only two modulation levels.

In embodiments, this aspect may be combined with any of the other features disclosed herein. Also, according to further aspects, there may be provided a corresponding method, computer-program and coded light signal.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a system comprising a coded light transmitter and receiver;

FIG. 2 schematically illustrates a packet transmission format for coded light, and DC components in the packet periods resulting from the transmission format when transmitted through an imperfect driver;

FIG. 3 is a graph showing how visible flicker components may be reduced by bi-level sub-symbol modulation;

FIG. 4 schematically illustrates how the DC component during idle periods between packets becomes more similar to the packet periods when the signal is modulated with bi-level sub-symbol modulation, thus reducing visible flicker;

FIG. 5 schematically illustrates a portion of a data signal encoded using a 5-level code, and a portion of the signal modulated with a bi-level sub-symbol modulation;

FIG. 6 is another schematically illustration of a portion of a data signal encoded using a 5-level code, and that portion modulated with a bi-level sub-symbol modulation;

FIG. 7 is a graph showing measurement results of light intensity in the frequency domain for an ideal (symmetrical) modulation, a non-ideal (asymmetrical) modulation, and a non-ideal (asymmetrical) modulation with bi-level sub-symbol modulation;

FIG. 8 schematically illustrates a Ternary Manchester coding scheme;

FIG. 9 schematically illustrates an example signal coded using Ternary Manchester; and

FIG. 10 schematically illustrates a bi-level sub-symbol modulation format.

### DETAILED DESCRIPTION OF EMBODIMENTS

FIG. 1 illustrates a coded light (CL) communication system comprising a transmitting device 2 and a receiving 4. For example the transmitting device 2 may comprise a luminaire for illuminating an indoor or outdoor space, and the receiving device 4 may comprise a mobile user terminal such as a smartphone or tablet.

The transmitting device comprises a light source 12, a driver 10 coupled to the light source 12, and a controller 3 coupled to the driver 10. The light source 12 is preferably an LED-based light source comprising one or more LEDs, but alternatively it could potentially take any other form such as a gas discharge lamp. The driver 10 is arranged to drive the light source so as to cause it to emit light, and the controller 3 is configured to control the emitted light via the driver 10 so as to modulate a data signal into the emitted light. To achieve this, the controller 3 comprises an encoder 6 and a modulator 8. The encoder 6 and modulator 8 may be implemented in the form of software stored on a memory of the transmitting device 2 (comprising one or more memory devices, not shown), and arranged for execution on a processor of the receiving device (comprising one or more processing units, also not shown). Alternatively the encoder and/or modulator 8 could be implemented in the form of dedicated hardware circuitry, or configurable or reconfigurable circuitry such as a PGA or FPGA, or any combination of software and hardware.

By whatever means implemented, the encoder 6 is arranged to receive unencoded data content 1 to be encoded from a data source such as an application (not shown), and to encode this into an encoded symbol comprising a stream of symbols of different symbol values. For example in a three-level code the symbols values are selected from amongst a set of symbol values −1, 0, +1; or in a five-level code the symbol values may be selected from amongst a set of symbol values −1, −½, 0, +½, +1. The modulator 8 is arranged to receive this encoded signal and to generate a drive signal 10 from the encoded signal, with which to drive the driver 10 and thereby modulate the data into the light emitted by the light source 12. The drive signal describes a waveform to be modulated into the light, where in the waveform consists of a series of different discrete, flat levels in the property of the light being modulated—in this case horizontal amplitude levels. These discrete levels in the drive signal, and therefore in the light, are used to represent the different possible symbol values of the encoded signal received from the encoder 6.

The receiving device comprises a light sensor 14, and a decoder 16 coupled to the light sensor. For example the light sensor 14 may take the form of a camera (such as a rolling-shutter camera), or a dedicated photocell. The decoder 16 may be implemented in the form of software stored on a memory of the receiving device 4 and arranged to run on a processor of the receiving device, or could alternatively be implemented in hardware or any combination of hardware or software. By whatever means implemented, the decoder 16 is arranged to receive the signal sensed by the light sensor 14 and to decode the data that has been modulated into the received light.

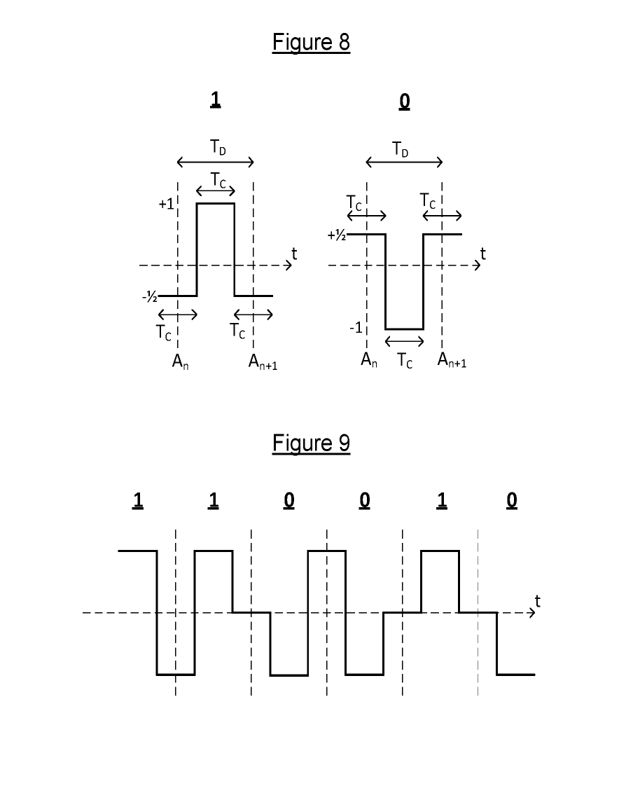

Ternary Manchester now forms a part of the state of the art and is thus known to a skilled person, but it is summarised again here for completeness. At the encoder 6, each data bit to be transmitted is mapped to a composite channel symbol in the form of a respective unit pulse. According to this scheme, there are two possible units, in the form of positive and negative “hat” functions as shown in FIG. 8. The pulse mapped to a data bit of value 1 is shown on the left hand side of FIG. 8, and the pulse mapped to a data bit of value 0 is shown on the right hand side of FIG. 8. A data bit is a bit of actual information to be conveyed in the transmission, sometimes referred to as “content data” or “user data” (even if not explicitly created by a user). The data bit period is labelled T_{D} in FIG. 8, with the boundaries between user bit periods shown with vertical dashed lines.

Each unit pulse comprises a sequence of elementary channel symbols of length T_{C} in time, smaller than the data bit period. Each elementary channel period consists of just one of the elementary levels that the coded signal can take, and is not alone sufficient to convey data (information) without being combined into a composite channel symbol. Hence each composite pulse of length T_{D} is the smallest or most fundamental unit of information (user data) that can be conveyed on the channel using the coding scheme in question, and the elementary channel symbols of length T_{C} are even smaller than this.

In the ternary Manchester code, each unit hat function (each composite symbol) comprises a sequence of three elementary channel symbols of length T_{C} in time, each half the length of the data bit period T_{D} (T_{D}=2T_{C}). The three elementary channel symbols for a respective data bit are contiguous, with the middle of the three being located at the centre of the respective data bit period, so that the adjacent first and third elementary channel symbols straddle the beginning and end boundaries of the data bit period T_{D} respectively by half an elementary channel period T_{C} either side.

For a data bit of value 1, this is mapped to the positive hat function shown on the left of FIG. 8. The positive hat function comprises: a first elementary channel symbol of height −½ centred on the beginning (earlier) boundary of the respective data bit period T_{D}, followed by second (middle) elementary channel symbol of height +1 being centred on the respective data bit period T_{D}, followed by a third elementary channel symbol of height −½ centred on the end (later) boundary of the respective data bit period T_{D}. The “height” at this stage may be represented in any suitable terms such as a dimensionless digital value (ultimately to be represented by the modulated signal property, typically amplitude).

For a data bit of value 0, this is mapped to the negative hat function shown on the right of FIG. 8. The negative hat function comprises: a first elementary channel symbol of height +½ centred on the beginning (earlier) boundary of the respective data bit period T_{D}, followed by second (middle) elementary channel symbol of height −1 being centred on the respective data bit period T_{D}, followed by a third elementary channel symbol of height +½ centred on the end (later) boundary of the respective data bit period T_{D}.

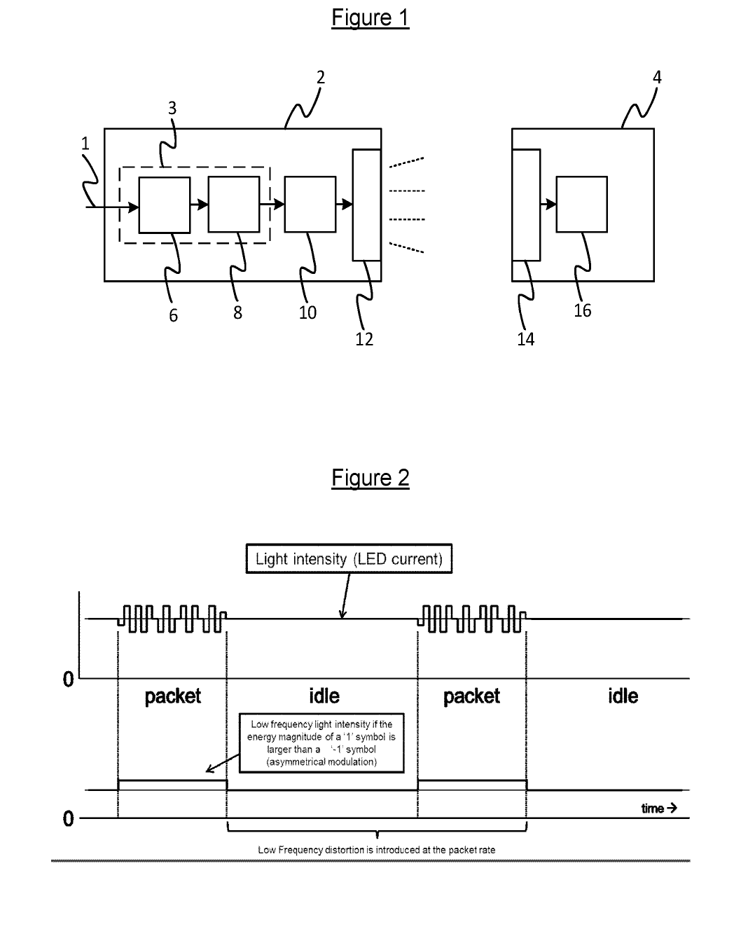

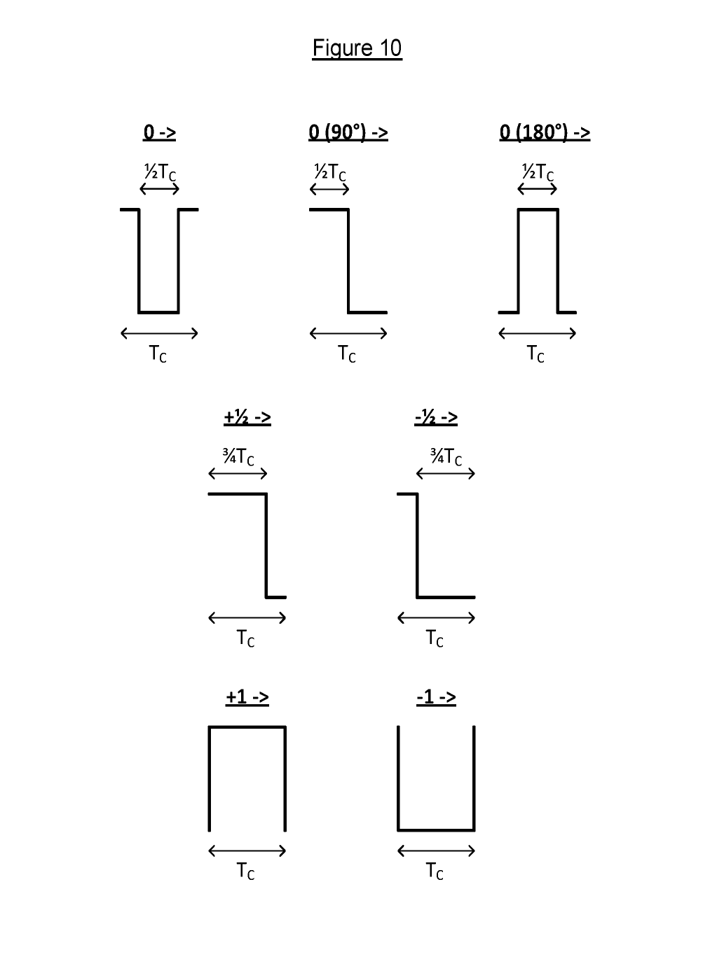

To create the encoded bitstream to be transmitted, the hat functions of adjacent user bits are added to one another, offset by the times of their respective bit periods T_{D}. Because the hat functions overlap across the boundaries between data bit periods, the functions add in the overlapping regions between adjacent data bits. That is, the hat functions are joined along the boundaries, so the earlier boundary Aₙ of one data bit period is joined with the later bit boundary Aₙ₊₁ of the preceding adjacent data bit period, with the height of the signal being summed where the two adjacent pulses overlap. An example of a resulting sequence of channel symbols in the time domain is shown in FIG. 9.

Where two adjacent data bits are of value 1, this means the two overlapping elementary channel symbols of height −½ add to a height of −1. Where two adjacent data bits are of value 0, the two overlapping elementary channel symbols of height +½ add to height +1. Where two adjacent data bits are of different values, the two overlapping elementary channel symbols of height +½ and −½ add to 0. Thus in the encoded stream, each user bit period (each unit pulse of information) takes the form of either a positive pulse of a rectangular wave when a user bit of value 1 is sandwiched between two adjacent user bits of value 1, or a negative pulse of a rectangular wave when a user bit of value 0 is sandwiched between two adjacent user bits of value 0, or an uneven pulse of one or four possible configurations with straight edges when at least one of the adjacent user bits is different. Note also that at the edges of a packet, the +½ and −½ levels remain (FIG. 2).

In an equivalent variant, the mapping of data bit values 0 and 1 to positive and negative hat functions may be reversed.

Conventionally, the resulting signal (e.g. that of FIG. 9) is then converted into a variation in the modulated property of the signal output by the transmitting light source (e.g. whether represented in terms of amplitude or frequency). For example, elementary channel symbol −1 may be represented by a low light output level, the elementary channel symbol +1 may be represented by a high output light level, and the elementary channel symbol 0 may be represented by an intermediate light level between the high and low.

The ternary Manchester code can be advantageous as it provides a smoother transition when the data bits change value than an old-fashioned binary Manchester code, and results in a spectrum in the frequency domain that is more suppressed around low frequencies where interference such as mains hum may occur. Particularly, ternary Manchester is not only DC free, but DC² free in that, in the frequency domain, not only does the distribution (Y vs f) go to zero at zero hertz, but also the gradient goes to zero at zero hertz. However, the applicability of the present disclosure is not limited to ternary Manchester and in other embodiments other examples of multi-level (≧3 level) coding schemes may be used.

The above explanation of ternary Manchester has been illustrated conceptually in terms of a signal having a “height” as shown in FIGS. 2, 9 and 10, but in fact at this stage, the resulting encoded signal as supplied from the encoder 6 to modulator 8 need only be represented in terms of a sequence of symbol values . . . 0, 0, −½, +1, −1, +1 (each selected from the finite symbol set −1, −½, 0, +½, +1). It is the modulator 8 that actually creates the waveform to be modulated into the light emitted by the light source 12. As will be discussed in more detail below, unlike the conventional case where a ternary Manchester signal like that of FIG. 9 is modulated directly into a proportional variation in the modulated property (e.g. amplitude) of the light, in embodiments of the present disclosure the modulator 8 does not represent the ternary Manchester signal directly in the shape of the drive signal, but rather converts the ternary Manchester encoded symbol stream to a bi-level sub-symbol modulation as will be described in more detail below.

In many applications, significant visible fluctuation of the light intensity is not allowed: visible flicker and stroboscopic effects should be avoided as much as reasonably possible.

Visible flicker occurs when the light intensity shows significant low frequency (LF) variations in the range [0-100] Hz. Flicker is avoided if these LF components are small enough to become non-noticeable by the human eye. The human eye is most sensitive for light intensity variations around 20 Hz.

The main source of low frequency (LF) components in the light intensity are the transitions between data packets and idle periods that occur in a packet based transmission format. These LF components are reduced by transmitting DC free packets. That is to say, the modulated data symbols within a packet represent on average an equal light intensity as in between the data packets. Coding formats such as Manchester Encoding ensure the absence of a DC component in the data packets relative to the idle periods, at least on average over multiple bits. In fact, some codes such as ternary Manchester are non-data-dependent, in that regardless of the data, the symbols of each individual user bitare DC free.

Nonetheless, even if the code is DC free in principle, DC components can still be introduced by an imperfect driver. As will be discussed in the following, LED driver amplitude precision requirements (or indeed those of other types of light source) can become less critical by using a bi-level modulation format, in accordance with embodiments disclosed herein.

The 5-level ternary Manchester format precisely describes the relative magnitude of the light intensity levels. In reality however, the different light intensities are created by a non-ideal lamp (e.g. LED) driver which introduces an error between the modulation format and the actual modulated light. LF light intensity components are introduced if the modulated packet turns out to be not exactly DC-free, for example due to non-linearity's of the LED driver. FIG. 2 shows how LF light intensity components are introduced if the magnitudes of the positive symbols are larger than the magnitude of the negative symbols. The top timing diagram in FIG. 2 shows packet based light intensity modulation over time in an idealized case, and the bottom timing diagram in FIG. 2 shows low frequency components being introduced if the modulated packets are in fact not DC-free.

High precision lamp drivers are commercially less interesting due to their high complexity and/or cost. This disclosure describes a two level modulation technique which significantly lowers the lamp driver amplitude precision requirement. That is to say, low frequency light intensity components become smaller resulting in less flicker, so that less complex and/or more cost effective lamp drivers can be used to modulate the light.

FIG. 3 shows the LF (flicker) components of an ideal traditional 5-level message next to the same message modulated by bi-level sub symbols. In both cases the message comprises discrete packets interspersed with an idle period between adjacent pair of packets, but the inventors have observed empirically that the bi-level sub-symbol modulation technique disclosed herein results in smaller LF components compared to the traditional modulation method. Smaller LF components increase the margin to the flicker visibility threshold, increasing the quality of light.

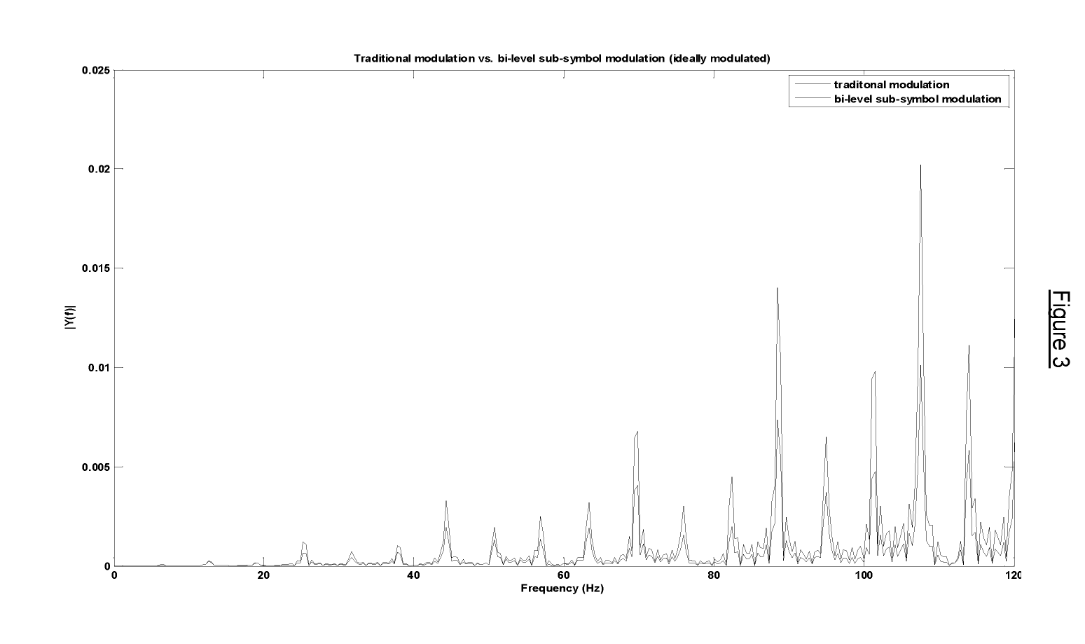

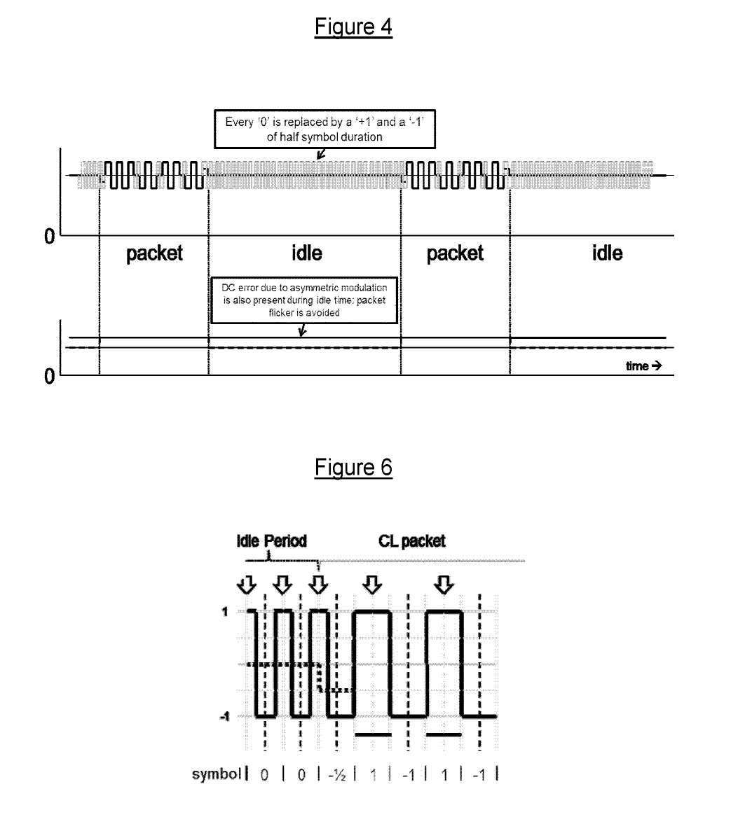

The idea is to keep on modulating during the idle period of the packets without changing the average light intensity within a symbol period. A DC error due to limited driver modulation amplitude precision is now always present, which leads to a small and stable light intensity offset instead of fluctuations at the packet rate. See FIGS. 3 and 4. The human eye is very sensitive to LF fluctuations but fundamentally lacks the ability to notice relatively small, stable light intensity offsets (small and stable relative to the average light level). The top timing diagram in FIG. 4 shows every symbol being modulated using only two light intensity levels, and the bottom timing diagram in FIG. 4 shows how packet flicker is avoided because two intensity levels are symmetrical by definition around their mean.

To modulate in between packets, in embodiments all symbols in the signal (i.e.

including the idle symbols) are split into fractional sub-symbols. The sub-symbols are chosen such that the average light intensity in one complete channel symbol period T_{C} equals the same light intensity as defined by the input modulation format (e.g. ternary Manchester in the example shown). For example: a zero symbol can be created out of an equal number of positive and negative sub-symbols, while a −½ can be created out of a ratio of three negative sub-symbols to one positive sub-symbol, a +½ can be created out of using three positive sub-symbols and one negative sub-symbol. A −1 is simply represented by the negative sub-symbol level, which could be considered as four negative sub-symbols and zero positive sub-symbols, and a +1 could be considered as four positive sub-symbols and zero negative sub-symbols.

Two sub-symbol amplitude levels are sufficient to create an arbitrary symbol level by adjusting the ratio between positive and negative sub-symbols. The two sub-symbol amplitude levels are fundamentally symmetrical around their mean which lowers the requirement on LED driver modulation amplitude precision and linearity.

Sub-symbol modulation introduces larger frequency components in the transmitted light. A typical receiver 2 however exhibits a low pass filter behaviour which filters out these frequencies resulting in the original signal. That is to say, the receiver's decoder 16 doesn't see a difference between traditional modulated coded light format (e.g. ternary Manchester) and the bi-level sub-symbol modulation using the technique disclosed herein. At the transmitter side 2 however, modulation precision and linearity have become less critical.

Note also that in embodiments, due to its filtering effect, the receiver 2 does not necessarily have to be modified in any way and can instead be a conventional ternary Manchester receiver (or conventional or unmodified receiver of whatever three-or-more level code is being used), the filtering effect being an inherent property of the receiver (e.g. due to the use of a matched filter to detect the ternary Manchester symbols or symbols of other such codes). Alternatively it is not excluded that an extra filter or state machine is added at the receiver designed specifically to recognise the bi-level symbol waveforms of the present disclosure.

The top timing diagram in FIG. 5 shows a traditional ternary Manchester modulation of an example coded light message, and the bottom timing diagram in FIG. 5 shows a bi-level sub symbol modulation of the same message according to a preferred embodiment (shown superimposed on the traditional modulation for the sake of illustration).

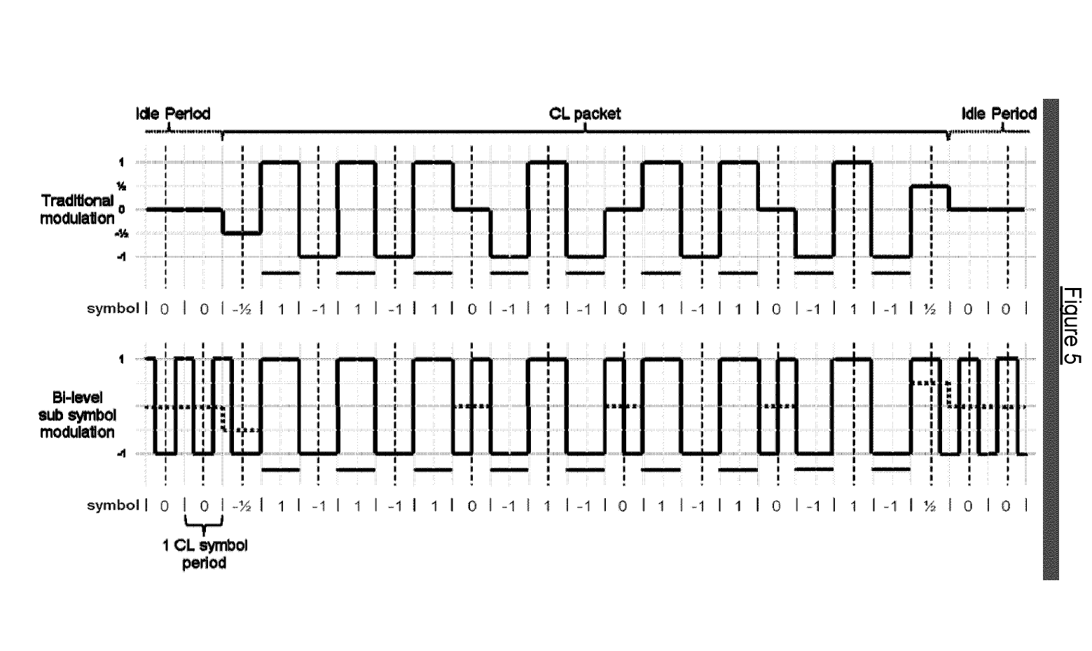

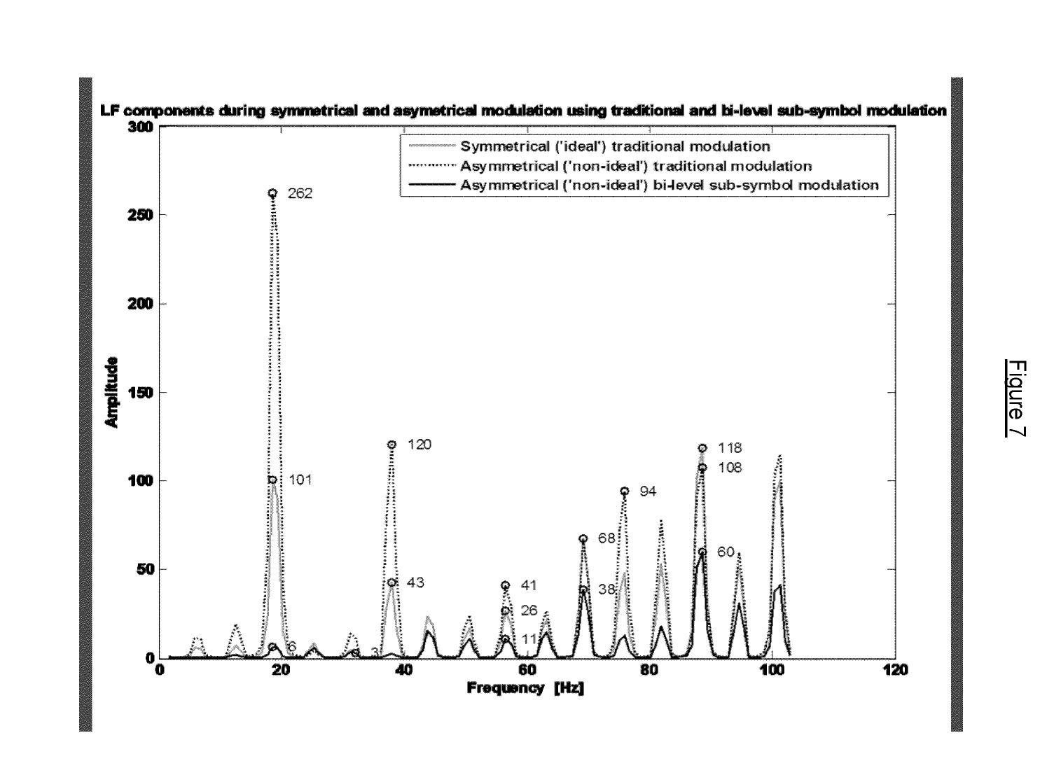

Note that the frequency of the sub-symbol waveform in the idle periods leading and trailing the coded light packet is larger than the frequency of the symbols in the coded light packet. The transition between those two frequencies may be implemented as described in European patent application no. 13 158 807.1. This transition is depicted in FIGS. 5 and 6. FIG. 6 shows the centre aligned waveforms of the idle period and packet, with the transition between the two implemented according to the alignment technique EP 13 158 807.1.

Note also that the modulated message in FIG. 5 shows a different phase of the sub-symbol waveform in the idle periods leading and trailing a given packet, and a different phase of the sub-symbol waveform representing the zeros symbols in the packet than the sub-symbol waveform representing the zero symbols in the idle periods. The sub-symbol waveform representing the zeros symbols in a given packet are 90 degrees out of phase with those in the leading idle period and trailing idle period, with the sub-symbol waveform representing the zeros symbols in the trailing idle period 180 degrees out of phase with those of the leading idle period. The purpose of this is to reduce flicker caused by the transitions at the beginning and ends of the packets. If such a combination of idle period (0° ph)-packet-idle period (180° ph) is to be transmitted continuously, the sub-symbol waveform phase has to jump somewhere from 180° to 0°. However, the inventors have observed that a sudden phase jump in the middle of the idle period doesn't seem to introduce flicker.

FIG. 10 shows the sub-symbol waveforms in closer detail. Each “elementary” channel symbol has a symbol period Tc, being common to all the symbols, i.e. each symbol lasts for a respective instance of the symbol period T_{C} (the symbol rate being the reciprocal of this symbol period, i.e. 1/Tc). According to the illustrated scheme of sub-symbol modulation, an “elementary” channel symbol of value 0 in the leading idle period in the encoded signal generated by the encoder 6 is mapped by the modulator 8 to a symbol waveform in the drive signal consisting of equal duration of a (flat) higher level and (flat) lower level, within the respective symbol period T_{C} of the respective channel symbol. In the following packet itself, any channel symbols of value 0 in the encoded symbol stream are mapped by the modulator 8 to the same drive signal waveform, but 90° out of phase with the waveforms of the zero symbols of the leading idle period. In the trailing idle period, the channel symbols of value 0 are again mapped to the same drive signal waveform, but this time 180° out of phase with the waveforms of the zero symbols of the leading idle period (and 90° out of phase with those of the packet itself). In all these zero symbol waveforms, the average DC signal level is half way between the first and second levels.

When a channel symbol of value +½ appears in a packet of the encoded signal generated by the encoder 6 on the other hand, this is mapped by the modulator 8 to a symbol waveform in the drive signal consisting of three quarters of duration of the respective symbol period T_{C} at the higher level and one quarter of the respective symbol period T_{C} at the lower level. Similarly, for a symbol value of −½ in the encoded stream, this is mapped to a symbol waveform in the drive signal consisting of one quarters of duration of the respective symbol period T_{C} at the higher level and three quarters of the respective symbol period T_{C} at the lower level. Thus for a symbol value of +1, the average signal level in the drive signal (over the respective symbol period T_{C}) is half way between the first level and the mid-point of the two levels (half way between the first level and the overall DC average for a packet, being the average zero level); and for a symbol value of −1 is half way between the second level and the mid-point of the two levels (half way between the first level and the overall DC average for a packet).

When it comes to a symbol value of +1 or −1 in the encoded signal from the encoder 6, there are mapped by the modulator 8 to a symbol waveform simply consisting of the first and second levels respectively, i.e. only the first level for the whole symbol period T_{C} for a +1 and only the second level for the whole symbol period T_{C} for a −1.

FIG. 7 shows measurement results of the light intensity spectra in three different situations: an ideal (symmetrical) modulation, a non-ideal (asymmetrical) modulation, and a non-ideal (asymmetrical) modulation with bi-level sub-symbol modulation. The LEDs were modulated by an arbitrary wave current source able to emulate both an ‘almost ideal’ LED driver and ‘non-ideal’ LED driver. In terms of flicker, the peak around 19 Hz is most important. Despite the absolute fault in LED driver current modulation, FIG. 7 shows that the bi-level sub-symbol modulation lowers the flicker components significantly compared to the traditional modulation method.

It will be appreciated that the above embodiments have been described only by way of example.

For instance, the applicability of the present disclosure is not limited to modulating the actual packets with the bi-level modulation as well as the idle periods, nor to using only a two-level modulation in the idle periods. Although the inventors have discovered through empirical observation that the technique is most effective when bi-level sub-symbol modulation is used in both the idle periods and packets, a similar effect can nonetheless be achieved to at least some extent even if only the idle periods are modulated with the bi-level modulation, with the actual packets still being modulated in the more conventional manner directly representing three-or-more levels of the signal from the encoder 6 (e.g. the 5-levels of the ternary Manchester symbol stream). More generally, it can be seen that, if the idle period was just all 0s as in the conventional case, then the driver would simply operate at a constant level in the idle periods; but if the idle periods are modulated using at least two levels, then the idle periods will experience the same or similar driver imperfections as are already being caused in the packets, and hence the same or similar offset as in the supposedly DC free code.

Other sub-symbol modulation schemes are possible as well. For instance, it is possible to use smaller sub-symbols and different distributions of sub symbols within one symbol period. The preferred embodiment presented above provided the lowest LF flicker components in a set of experiments where the sub-symbol distribution (with a sub symbol size of ¼ symbol) within one symbol interval was adjusted in each experiment. Nonetheless, other sub-symbol distributions were still effective to an extent.

Note that the upper and lower (e.g. first and second) levels of the modulation can be any levels, and do not necessarily correspond to 0% and 100% light intensity. E.g. the first level may be signalled in the emitted light by 80% light intensity, and the second level by 70%, in which case being DC free means the average (at least for substantially random data) is 80%. In general the DC average of the “zero” symbol waveform is only be referred to as the zero as an arbitrary origin. So in the example of first and second levels causing 70% and 90% intensity, then 80% intensity is “zero” from the perspective of the waveform modulated into the light. The relevant consideration for reducing flicker is that the “zero” level (the DC average of the idle periods) is substantially similar to the DC average of the packets, including in the light levels as output by the imperfect driver 10.

More generally still, the applicability of the present disclosure is not limited to the modulated property of the light being amplitude. Another example is duty cycle modulation, where light is switched on an off (or between high and low) during each of a sequence of periods, with a variable ratio between the on and the off times, or high and low times. In this case the modulated property is this ratio, i.e. the duty cycle, rather than the amplitude.

Note also, regardless of the modulated property, where is said that the average symbol value or modulation level is zero for substantially random data, this includes this approximation that most arbitrary user data tends to be effectively random from the perspective of the encoding scheme. The data does not have to be “random” in the strict, truest sense.

Further, the scope of the present disclosure is not limited to ternary Manchester as the code used by the encoder 6. In general, the code could be any three-or-more level code that is DC free.

With regard to the DC-free nature of the code itself, as opposed to the modulation scheme, note that the data values in the encoded bitstream are not necessarily the same as the symbol values. I.e. the actual digital value in the bitstream output by the encoder 6, before used by modulator 8 to create a waveform, with which to driver the driver 10, could be any arbitrary value used to represent each symbol, not necessarily equal to, proportional to or even mathematically related to the symbol value it represents (corresponds to). Nonetheless, in the case of a DC free code, the symbol values are meaningful at least in that there exists (i.e. can be found) a set of values such that the average of the symbol values weighted by their probability of occurrence in the signal (at least for random data) is equal to one of the symbol values in the set. The “zero” symbol value is this symbol by definition, and the other symbol values are positive and negative values either side such that said condition is met.

So for a set of symbols A, B, C, D, E represented arbitrarily in the encoded bitstream, the symbol “values” are those such that if symbol C is said to represent a symbol value of 0, and symbol A, B, D, E are said to represent symbol values V_{A}, V_{B}, V_{D}, V_{E}, then these are values such that the average of V_{A}, V_{B}, V_{D}, V_{E} weighted by their rate of occurrence or probability of occurrence is equal to zero. Or more generally, for a set of symbols . . . S_{-N}, . . . S₀, . . . S_{N} represented arbitrarily in the encoded bitstream, the symbol values are those such that if symbol S₀ is said to represent a symbol value of 0, and symbols S_{-N}. . . Sₙ₋₁ and S₁ . . . S_{N} are said to represent symbol values V_{-N}, V−₁, V₁, V_{N}, then these are the values such that the average of V_{-N}, V₋₁, V₁, V_{N} weighted by their rate of occurrence or probability of occurrence is equal to zero.

If there is an equal occurrence of A and E, and an equal occurrence of B and D, (or indeed for certain other combinations with different probability distributions) then the symbol values are equally spaced. Note it is arbitrary whether these are called −1, −½, 0, +½, +1 or, for example, −2, −1, 0, +1, +2. Or if there is an equal occurrence of S_{-N} and S_{N}, and an equal occurrence of S_{-(N-1)} and S_{N-1}, etc., (or indeed for certain other combinations with different probability distributions, then the symbols represent an equal number of equally-spaced positive and negative values symmetrical about zero.

E.g. the DC-free code could be a three level code −1, 0 and +1 with an equal occurrence or probability of occurrence of the −1 and +1 symbols; or for a five level code −1, −½, 0, ½, +1, with equal occurrence or probability of occurrence of +1 as −1, and equal occurrence or probability of occurrence of −½ as +½.

Note that a two level code can never have the above property, as whatever values are attributed to the symbols, the average always falls somewhere between and can never equal to one of the symbol values. One could potentially even have a four level code −1, 0, +1, 2, if negative values occur more often than the positive values. But a 4-level code would not meet the DC free requirement for four equally occurring symbols: in that case there can be no value for which the average is also one of the symbol values.

The point is that for a code with the above-described a property, i.e. for a DC code, it would be theoretically possible to represent this in the modulated waveform using levels corresponding to the symbol values with the zero symbol being the idle or “at rest” state, such that in the waveform the idle periods could be created from the same signal level as one of the symbols of the packets and the idle period would have the same DC level as the average DC of the symbols. Hence one might think there was no reason to modulate the idle periods, because in principle the code would seemingly always have the same average DC level of 0 as the idle period. However, once one realizes the issue that the imperfect driver 10 results in a DC offset in the packets even for a DC free code, then it can be seen that the modulation in the idle period becomes relevant.

If the code used by the encoder 6 was a simple binary code of only 1s and 0s then it may be apparent that, if the idle period was all 0s, then without also modulating the idle period, there would be a low frequency component due to oscillation between the DC level of the packets and the 0 level of the idle periods (see US 2010/0284690). But in the case where the code used by the encoder 6 is a three-or-more level DC-free code where the average symbol value is equal to one of the symbol values in the set (the zero value by definition), e.g. as in various three or five level codes such as Ternary Manchester, then one might imagine the idle period does not matter because the idle period could just be represented by the zero symbol. It is only by noticing that imperfections in the driver cause a DC component in the packets, but not an equivalent component in the idle period, that there becomes a reason to modulate the code in the idle period—i.e. to mimic the same driver imperfections.

Regarding the drive signal itself (i.e. representing the actual waveform), this is DC free at least in that the average level in the packets is the same as the idle periods. Also, the average of one packet is equal to the average of another packet. In fact in certain codes such as ternary Manchester, the code is not data dependent, so the average level for one user bit (for each bit of data content) is always the same as the average for the next (always zero). However, the applicability of the techniques disclosed herein is not limited to such non-data-dependent codes, and in general it may be that the waveform is DC free in that (for at least substantially random data) the average is approximately constant from packet to idle period, and preferably packet-by-packet. Further, the schemes according to the present disclosure do not necessarily have to result in a DC free modulation that is perfectly devoid of DC, but rather for the purpose of the present disclosure, the modulation may be considered DC free if sufficiently so to avoid visible flicker for at least some (non-visually-impaired) users.

Further, note that while the above has been described in terms of an encoder which produces an encoded symbol stream (e.g. from the set −1, −½, 0, +½, +1), and a modulator 8 which converts this to the waveform of the drive signal, in alternative embodiments it is possible that the modulator 8 takes the form of a state machine that maps the input data 1 directly into the waveform of the drive signal (e.g. directly from the 0s and 1s of the input data to the bottom waveform of FIG. 5). In this case although the encoded signal do not necessarily exist in the form of an intermediate stream symbols values (e.g. −1, −½, 0, +½, +1), the drive signal nonetheless still represents these values in the form of the three-or-more different bi-level symbol waveforms (e.g. of FIG. 11). In embodiments these values may still be recovered by the filtering effect of the receiver at the decode side (or alternatively mapped straight back to the data original data bits).

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A controller comprising:
an encoder configured to encode packets of data into an encoded signal according to an at least three-level code comprising a set of at least three discrete symbols in the form of a zero symbol corresponding to an average symbol value, at least one positive symbol corresponding to a higher symbol value, and at least one negative symbol corresponding to a lower symbol value, wherein the code if DC-free in that, at least when the data is substantially random, the symbol values average to said average symbol value; and
a modulator configured to receive the encoded signal from the encoder and to generate therefrom a drive signal for driving a driver of a light source to transmit a signal embedded in visible light emitted by the light source, the drive signal having a waveform with discrete levels used to represent the packets of encoded data and the packets being interspersed with idle periods;
wherein, at least when the data is substantially random, the levels of the drive signal have a predetermined average DC level during the packets; and
wherein the modulator is configured to use, in the drive signal, a DC-free modulation alternating between a plurality of levels comprising at least a first level and a second level to represent the idle periods, the DC-free modulation being DC-free in that over each of the idle periods the levels average to the same predetermined average DC level as during the packets.

2. The controller of claim 1, wherein in the drive signal, the data is encoded at a symbol rate of said symbols, and at least during the idle periods the modulation alternates between the first and second levels at a higher frequency than said symbol rate.

3. The controller of claim 2, wherein in the drive signal, during the idle periods the modulation alternates between the first and second levels at twice the symbol rate.

4. The controller of claim 2, wherein each of the idle periods corresponds to a sequence of the zero symbols, and wherein said modulation comprises representing each of the zero-symbols of the idle periods in the drive signal by a symbol waveform comprising a combination of the first and second levels.

5. The controller of claim 1, wherein said modulation is a bi-level modulation, comprising only the first and second levels.

6. The controller of claim 5, wherein the modulation comprises, in the drive signal, representing each instance of the zero symbol with a symbol waveform consisting of an equal duration of the first and the second levels.

7. The controller of claim 1, wherein each of the idle periods corresponds to a sequence of the zero symbols; and the modulator is configured to use the DC-free modulation in the drive signal to represent both the idle periods and the packets, by representing each of instance of each said symbols using one or both of the first and second levels.

8. The controller of claim 7, wherein said modulation at least comprises, in the drive signal, representing each instance of the zero symbol during the idle periods with a symbol waveform comprising a combination of said first and second levels, and representing each instance of the zero symbol during the packets with the same symbol waveform but 90 degrees out of phase with the zero symbols of the idle periods.

9. The controller of claim 7, wherein:
the at least one positive symbol of said set comprises a +1 symbol, and the at least one negative symbol of said set comprises a −1 symbol; and
said modulation comprises, in the drive signal, representing each of the zero symbols with an equal duration of the first and the second levels, representing each of the +1 symbols by only the first level, and representing each of the −1 symbols by only the second level.

10. The controller of claim 1, wherein the symbols of said at least three-level code correspond to an odd number of levels with an equal number of evenly spaced levels either side of the zero level.

11. The controller of claim 1, wherein said code is an at least five level code.

12. The controller of claim 11, wherein said code is an exactly five level code.

13. The controller of claim 10, wherein:
the positive symbols of said set comprise a +½ symbol and a +1 symbol, and the negative symbols of said set comprise a −½ symbol and a −1 symbol; and
said modulation comprises, in the drive signal, representing each of the zero symbols with a symbol waveform consisting of an equal duration of the first and the second levels, representing each of the +1 symbols by only the first level, representing each of the −1 symbols by only the second level, and representing each of the +½ symbols with a symbol waveform consisting of three quarters duration of the first level to one quarter duration of the second level, and representing each instance of the −½ symbol with a symbol waveform consisting of one quarter duration of the first level and three quarters duration of the second level.

14. (canceled)

15. A system comprising a transmitter comprising the controller of claim 4, and further comprising a receiver arranged to receive the light embedded with the signal emitted by the light source controlled by the controller, wherein the receiver is arranged to low pass filter said signal to average out the modulation between the first and second levels per symbol, and thereby recover the symbol values of said at least three-level code.

16. A method of embedding data in visible light emitted by a light source, the method comprising:
generating a drive signal having a waveform having discrete levels used to represent a sequence of packets of encoded data interspersed with idle periods, wherein the packets of data are encoded according to an at least three-level code comprising a set of at least three discrete symbols in the form of a zero symbol corresponding to an average symbol value, at least one positive symbol corresponding to a higher symbol value, and at least one negative symbol corresponding to a lower symbol value, wherein the code is DC-free in that, at least when the data is substantially random, the symbol values average to said average symbol value being the value of the zero symbol; and
driving a driver of the light source with the drive signal to transmit the sequence of packets and idle periods embedded in the emitted visible light;
wherein, at least when the data is substantially random, the levels of the drive signal have a predetermined average DC level during the packets; and
wherein the method comprises, in the drive signal, representing the idle periods using a DC-free modulation alternating between a plurality of levels comprising at least a first level and a second level, the DC-free modulation being DC-free in that over each of the idle periods the levels average to the same predetermined DC level as the packets.
